(19) United States
(12) Patent Application Publication
(10) Pub. No.: US 2008/0133569 A1
(43) Pub. Date: Jun. 5, 2008

(54) SYSTEM AND METHOD FOR CONTENT HANDLING AND BUNDLING FOR MOBILE HANDSET DEVICE

(75) Inventors: Vincent Vu, Los Angeles, CA (US); Kiyoto Hirai, Torrance, CA (US); Seth Cummings, North Hollywood, CA (US); Michael McSherry, Los Angeles, CA (US)

Correspondence Address: SCULLY SCOTT MURPHY & PRESSER, PC, 400 GARDEN CITY PLAZA, SUITE 300, GARDEN CITY, NY, 11530, US

(73) Assignee: Amp'd Mobile, Inc., Los Angeles, CA (US)

(21) Appl. No.: 11/566,110

(22) Filed: Dec. 1, 2006

(51) Int. Cl. G06F 17/30

(52) U.S. Cl. 707/102; 707/E17.005

(57) ABSTRACT

A novel system, method and computer program product for accessing digital media files via a mobile phone device having a user interface adapted for initiating search requests for digital content associated with a searched category. The method for providing digital content for user search and selection via his/her mobile phone comprises receiving metadata content from one or more content providers equipped to transmit digital content to a user's digital phone, aggregating the received metadata content including heterogeneous content types, and generating a catalogue representing the aggregated metadata content. A further step includes accessing the aggregated metadata content catalogue and retrieving catalogued metadata in accordance with a received user request. A single web page including metadata from the aggregated metadata content catalogue is generated that is adapted for receipt by the mobile phone and presentation via the user interface, thereby providing a user with integrated access to multiple heterogeneous content types via the single web page. The aggregating of the received metadata content includes bundling of metadata content associated with the heterogeneous content types. In one aspect, the bundling of metadata content associated with the heterogeneous content types is theme-based.

### BACKGROUND OF THE INVENTION

1. Field of the Invention

The present invention generally relates to mobile handset devices, and particularly to a novel mobile handset user interface and back end system support infrastructure that enables presentation of 3G content including music, video, news, lifestyle, entertainment, sports and gaming to users in a more relevant, personal and meaningful way.

2. Description of the Prior Art

Wireless communication such as mobile telephones and digital devices are ubiquitous in today's society. Historically, wireless communication devices, e.g., cellular telephones, pagers, and other two-way messaging devices, have had the ability to receive data and/or voice messages sent from a wireless communication system. However, with the advent of the Internet, besides traditional message communications, higher performing wireless communication devices have been provided with complete Internet access. That is, with wireless communication devices now provided with a browser or micro-browser applications, users may directly browse and download digital content from the Internet/World Wide Web. Examples of content now available for download to cellular and mobile phones include: pictures (e.g., jpeg, gif, png), ringtones in MIDI and other formats, video, audio (e.g., songs) and A/V presentations (e.g., music videos), games, wallpaper, etc.

Besides basic wireless communication functionality, other technical achievements have been coupled with these innovations, particularly in the manner in which Internet and World Wide Web content providers integrate with other communications functionality to provide downloadable content to such devices, e.g., OTA or Over The Air download. Additional innovations are directed to the user interface, i.e., the most visible layer of the wireless communication device's software that manages the screen display and processes user inputs of key presses.

Current players in the market offering wireless phone technology, for example, Verizon's Vcast™ technology that provides a 3G Evolution Version Data Only (EVDO) network used for OTA downloading and streaming of video clips and music to compatible mobile telephone devices, implement a permanently installed application, e.g., a BREW® application. However, such devices that are compatible with Vcast, for example, requires a user to first go through ‘middleman’ software to access each different type of heterogeneous content, e.g., music videos, games, wallpaper, ringtones, etc. before it can be accessed by the handset. That is, via a Vcast compatible device providing a user interface, the user would have to select one content type, e.g. associated with a particular category, e.g., an actor, artist, musician or television show, in addition to selecting the application with which to download that content. That is, the exercise of selecting a desired type of content and accessing the “middleware” application to download the desired content must be performed for each piece of content thereby hampering the user's ability to efficiently download heterogeneous types of content associated with that particular category to the mobile handset.

It would be highly desirable to provide a mobile handset device and support networking infrastructure that provides the ability for the user of the handset to eliminate the additional steps of accessing an application for each type of content desired to be downloaded.

It would further be highly desirable to provide a mobile handset device and content provision methodology that provides the ability for the user of the handset to automatically access heterogeneous types of content (e.g., a ringtone, a video and a wallpaper download) associated with a particular category (e.g., a particular actor, artist, musician or television show, etc.) via a single user interface.

It would additionally be highly desirable to provide a novel user interface (UI) for a mobile handset device (e.g., mobile phone) designed to provide an interactive experience that uniquely presents targeted content and services.

### SUMMARY OF THE INVENTION

The present invention is a novel system, method and computer program product that supports seamless ‘one stop shopping’ access to heterogeneous pieces of content via a mobile handset device.

The novel system, method and computer program product for accessing digital media files via a mobile phone device includes a user interface adapted for initiating search requests for digital content associated with a searched category. The method for providing digital content for user search and selection via their mobile phone comprises receiving metadata content from one or more content providers equipped to transmit digital content to a user's digital phone, aggregating the received metadata content including heterogeneous content types, and generating a catalogue representing the aggregated metadata content. A further step includes accessing the aggregated metadata content catalogue and retrieving catalogued metadata in accordance with a received user request. A single web page including metadata from the aggregated metadata content catalogue is generated that is adapted for receipt by the mobile phone and presentation via the user interface, thereby providing a user with integrated access to multiple heterogeneous content types.

In one aspect of the invention, the aggregating of the received metadata content includes “bundling” of metadata content associated with the heterogeneous content types. The bundling of metadata content associated with the heterogeneous content types is theme-based.

Exemplary “Themes” for which heterogeneous types of content are bundled for integrated access via a user's mobile phone include, but are not limited to, a theme corresponding to: an artist, an entertainer, a movie title, a song title, a television show, a sports team, a live event.

Thus, according to one aspect of the invention, there is provided a system for presenting digital content on a mobile phone including a user interface adapted for initiating search requests for digital content associated with a searched category and downloading digital content, the system comprising:

a first means (CMS) for receiving metadata content describing digital content available for download to a user's digital phone from one or more content providers, the first means further aggregating metadata content including heterogeneous content types and generating a catalogue representing the aggregated metadata content; and,

a second means (HCS) for accessing the aggregated metadata content catalogue and retrieving catalogued metadata in accordance with a received user request, the second means further generating a single web page including metadata from the aggregated metadata content catalogue that is adapted for receipt by the mobile phone and presentation via the user interface,

wherein the first means for aggregating metadata and the second means for retrieving the aggregated metadata catalogue cooperatively interact to provide a user with integrated access to multiple heterogeneous content types via the single web page.

In an exemplary embodiment, the digital content includes one or more of: music, video, wallpaper, screensavers and ringtones, downloadable via said user interface.

According to a further aspect of the invention, there is provided a method for providing digital content on a mobile phone, the phone including a user interface adapted for initiating search requests for digital content associated with a searched category and downloading digital content, the method comprising:

receiving metadata content describing digital content available for download to a user's digital phone at a first server device (CMS) from one or more content providers;

aggregating, at the first server device, the received metadata content including heterogeneous content types and generating a catalogue representing the aggregated metadata content;

accessing, at a second server device (HCS), the aggregated metadata content catalogue and retrieving catalogued metadata in accordance with the user request; and,

generating a single web page including metadata from the aggregated metadata content catalogue that is adapted for receipt by the mobile phone and presentation via the user interface, thereby providing a user with integrated access to multiple heterogeneous content types via the single web page.

### BRIEF DESCRIPTION OF THE DRAWINGS

The objects, features and advantages of the present invention will become apparent to one skilled in the art, in view of the following detailed description taken in combination with the attached drawings, in which:

FIG. 1 conceptually depicts the support network infrastructure for a client device, i.e., a mobile phone, provisioned to enable communications and content download functionality over a wireless carrier network according to the present invention;

FIG. 2 depicts in more detail, the networking infrastructure for downloading content to a client device, i.e., a mobile phone, over a wireless carrier network according to the present invention;

FIGS. 3A and 3B each depict an exemplary handset user interface 100 showing the results of content aggregation at the CMS and HCS that enables the ‘one stop shopping’ access to heterogeneous pieces of content according to the invention;

FIG. 4 depicts a handset's user interface 100, specifically, the device's user interface for downloading content in accordance with the present invention;

FIG. 5 in general depicts an example of a back-end relational data content categorization scheme enabled to provide users via their ALUI individual user interface on the mobile handsets the ability to access each of the myriad of downloadable heterogeneous content types 225 (e.g., video clips, voice tones, games, wallpapers, greetings, video, screensavers, fan blogs, greetings, soundtracks, sweepstakes, ‘meet the actors’, etc.) via a single ‘storefront’;

FIG. 6 is a sequence diagram depicting the content bundling process 300 for a mobile device handset back-end infrastructure according to the invention; and,

FIG. 7 depicts an alternate embodiment of the support network infrastructure for downloading content to a client device, i.e., a mobile phone, over a wireless carrier network according to the present invention.

### DETAILED DESCRIPTION OF TEE PREFERRED EMBODIMENTS

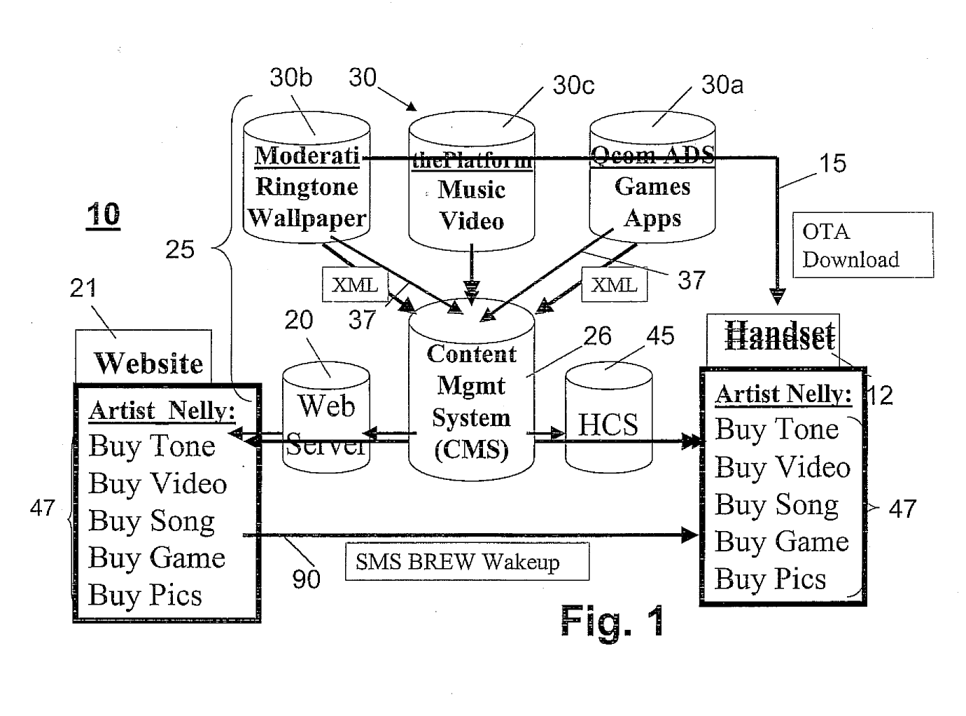

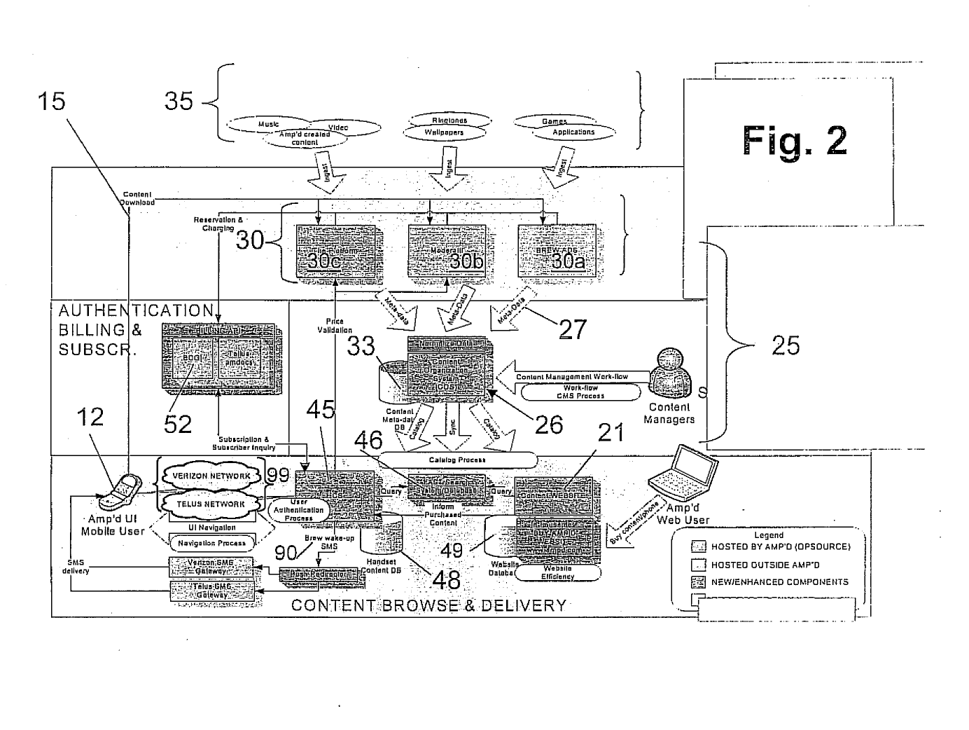

Referring now to drawings, and particularly to FIGS. 1 and 2, there is shown the overall computing and communications environment 10 in which the present invention may be implemented.

As shown in FIG. 1, there is depicted a client device 12, i.e., a mobile phone, which can be any mobile phone enabled for communications functionality over wireless carrier networks. In addition to providing phone functionality, such devices may be categorized as “smart” phones including functionality of a Personal Digital Assistant (PDA). Thus, besides the processing ability to perform basic mobile telephone communications, the client is provided with the capability of searching and downloading Internet/web content, and further executing applications, such as applications enabling mobile instant messaging, short messaging service, sending/receiving e-mails, message management, etc. As further shown in FIG. 1, the service provider provides a web server 20 adapted to provide identical Internet/web content downloads as available to the mobile device for users who may be on-line via a computer based browser device (not shown) and wish to browse/purchase content via their personal computers, for example.

Current mobile devices enabling these applications include, but are not limited to devices provided by manufacturers such as: Motorola Inc., Samsung Inc., Nokia Inc., LG Inc., Sanyo Inc., Qualcomm Inc., Kyocera Inc., and NTT DoCoMo Inc. However, while the device's hardware configurations vary, each device employs a basic computing platform that can receive and execute software applications and may include application specific integrated circuits (ASIC) or other processor, a microprocessor (e.g., some may be provided with Intel x86 platform, PowerPC platforms, etc.) or logic circuits. The ASIC phone executes application programming interfaces (API) that interface with programs resident in the memory of the wireless device. Such memory may comprise one or more of a volatile or non-volatile memory (e.g., RAM/ROM), EPROM, flash memory, etc. As known, the software platform of such devices includes a small form factor operating system catered for mobile devices. Such mobile operating systems that may be implemented include: but are not limited to Symbian®, Microsoft Windows Mobile®, Palm® OS and the Binary Runtime Environment for Wireless (BREW®) available from Qualcomm.

According to the invention, the mobile handset device 12 executes program code that provides a novel user interface referred to hereinafter as the Amp'd Live™ User Interface (“ALUI”) designed to provide an interactive experience that uniquely presents targeted content and services to users/subscribers. That is, the mobile handset 12 has architected a “mobile shop” user interface designed to appeal and identify with targeted demographics and exceed the expectations of the target customer, e.g., by offering a constantly updated portal, and the ability to dynamically refresh the device's content menu with the latest entertainment, information, communication, and user generated content. While existing carrier data decks are presented in basic text and icon layouts that offer little visual appeal to users and hence, do not offer a compelling draw into the rich world of multimedia, video, 3D and meaningful participative community experiences, the handset device 15 of the invention incorporates its unique ALUI design/features into the BREW MobileShop® (Trademark of QUALCOMM Incorporated). In one exemplary, but non-limiting embodiment, the ALUI is developed as a BREW® 3.1 application for mobile phone handsets and is preloaded to these handsets. However, it is understood that the ALUI is easily portable to other high-end digital devices e.g., PDA's, cell phones, etc. As will now be explained, the ALUI supports downloading of various contents catalogue and Evolution Version Data Only (e.g., EVDO/1×) contents binaries by interacting with contents distribution servers/networks. For instance, the ALUI is enabled to interact with external servers for downloading content catalogues and content binaries, including, but not limited to: music video (e.g., WMV, 3gp, 3gpp2, mp3, etc. formats); full track digital music (e.g., WMA PRO format); Realtone/Ringtone (WMA/Poly formats); BREW® Game/Applications (BREW® formats); and, Wallpaper (e.g., JPEG/GIF/BCI) on BREW®. Additionally, the ALUI is enabled to interact with external servers that perform user authentication and billing processing.

As further shown in FIG. 2, the mobile handset device 12 can be any mobile phone enabled for communications functionality over service provider and carrier networks 99. The device 12 is further adapted to wirelessly download content 15 via over-the-air (OTA) transfer protocol or like protocols known in the art (e.g., the Open Mobile Alliance (OMA) over-the-air (OTA) download protocol for generic content download, also referred to as the OMA Download OTA (DLOTA)). In one embodiment, a back-end content management system (CMS) 25, embodied, for instance, as a CMS server or plurality (cluster) of server devices 26 implemented by a service provider, e.g., Amp'd Mobile Inc.™, is provided to perform content ingestion, adaptation and storage functionality. Particularly, one or more content providers 30 providing content 35 such as ringtones, wallpaper, music, video, games, applications (e.g., location based service, navigation, etc.) and even customized content provided by the carrier, would make available such content to subscribing mobile users. In order for the wireless device 12 to receive content downloaded from the service providers, an “ingestion” process first takes place that is performed by the back-end CMS 25 that receives the content to form a catalog. As will be explained in greater detail herein, a content provider provides metadata 27 describing the particular content that the provider is making available for download to the mobile device users. The back-end content management system “ingests”, i.e., normalizes and aggregates, the metadata information representing the heterogeneous types of content currently available for download to a user device for storage in the form of one or more content catalogues. In the embodiment described herein, the metadata 27 describing the downloadable content is in the form of an XML file 37, however it is understood that the invention may implement other types of metadata formats for representing the content. The XML files from the content providers are particularly ingested into the CMS to form a database 33 including the content catalog web pages as shown in FIG. 2. As will be further described herein, a back-end handset content server (HCS) device 45 operates in conjunction with the CMS to provide downloadable mobile web pages comprising the catalogued content for receipt by the mobile handset 12.

### ALUI

According to the invention, in response to user search requests for content via the mobile handset's ALUI, the aggregated XML metadata is packaged by the HCS 45, operating in conjunction with the CMS 26, to form downloadable mobile web pages providing catalogued metadata content for presentation to the mobile handset's browser application. In one embodiment, the web pages comprising packaged catalogue metadata content may be similarly downloaded to an identical user interface (ALUI) provided by the service provider's website 21 (e.g., www.ampdmobile.com) embodied by the web server 20 (as shown in FIGS. 1 and 2) for preview and purchase of content on-line, e.g., via the user's PC browser application.

In a preferred embodiment of the invention, the aggregated XML metadata is processed in a manner that facilitates the bundling of content associations. More specifically, the aggregation of heterogeneous types of content 47 by the CMS enables the advantageous presentation of content to the user in a “one stop shop” on the wireless device. For example, bundled content associations may be packaged according to a “Theme”, e.g., a user's favorite football team, a favorite television program, or an entertainer. Thus, for example, heterogeneous content types, e.g., ringtones, wallpapers, and screensavers may be provided that all relate to that bundle's theme. To accomplish this, the CMS ingested metadata is first aggregated, in a process referred to as content association, into a specific page. That is, the heterogeneous types of content 47 associated with a category, e.g., an entertainer “Nelly”, is aggregated for presentation to the user as one web page in the content association process. Thus, as shown in the conceptual system view of FIG. 1, a user, via his/her mobile wireless device 12, will be able to retrieve a dedicated mobile web page 15 downloaded via the OTA protocol including the aggregated content associated with a bundled category, e.g., associated with the entertainer “Nelly”. Once the page is downloaded, that user will be able to access each of the types of aggregated content 47, e.g., ringtones, wallpaper, screensaver, video, music, etc., associated with that entertainer from that downloaded mobile web page. In this manner, a user is able to configure his/her mobile phone to reflect his//her own personality. The CMS, in cooperation with a handset content server (HCS) device 45 that executes a server application to host and provide content catalogue data tailored for the handset UI, presents this single mobile web page as a “storefront” that enables seamless ‘one stop shopping’ access to each heterogeneous piece of content available. More particularly, the ALUI interacts with the HCS device 45 server application to perform additional tasks including, but not limited to: 1) performing user authentication whereupon the HCS performs user authentication by interacting with a carrier network implementing, for example, an authentication server (e.g., Verizon's AAA authentication server); 2) performing contents catalogue data downloads including content metadata (text info), preview video clip/graphics/animation, promotional information, content category information, etc.; 3) providing ALUI navigation instruction particularly by enabling downloading of XML files that give instruction enabling users to navigate via the ALUI; and, 4) performing skin themes package downloads comprising graphics, binaries and metadata that describe the common ALUI graphical presentation elements including: basic screen display layout, header and footer areas, page and menu transitions, buttons (e.g., color, functions and effects), icons (e.g., color, functions and effects), label text, contents listing, and contents metadata.

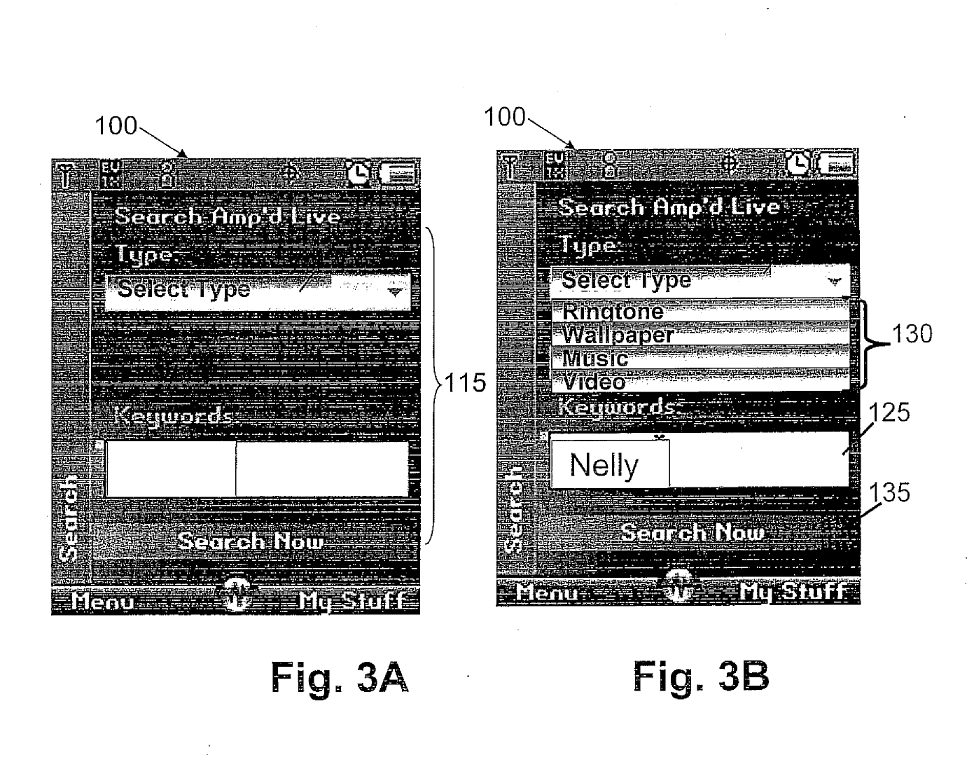

FIGS. 3A and 3B depict an exemplary handset ALUI interface 100 showing the results of content aggregation that enables the ‘one stop shopping’ access to heterogeneous pieces of content. As shown in FIG. 3A, via the device's ALUI interface 100, a user will be able to navigate to a first search web page 115 that includes a drop-down menu box 120, such that when the menu box is selected, it will display user selectable options 130 of the downloadable content types available, e.g., ringtones, wallpaper, video and music such as shown in FIG. 3B. Additionally, once a particular type of content is selected, e.g., wallpaper, the user will be able to enter characters of the particular category, e.g., the entertainer Nelly, via the handset keypad provided with the mobile phone, in entry field 125 as shown in FIG. 3B. Upon subsequent selection of the displayed search button 135 via mobile handset search page 115, there is formed for display a second webpage (not shown) presenting a list of the available types of wallpaper associated with the entertainer, e.g., Nelly, that a user may further select for preview and/or purchase. In general, a subscriber can find particular content downloads of packaged bundles through a content search function. To search content, a subscriber can specify: by Content Category (selectable—music, video sports, entertainment, games, etc) according to a genre, artist or title; by Contents Type (Video, Music, Ringtone, Games, Wallpaper, etc); or, by Text string. In further view of FIG. 2, particularly, the search request is sent to the HCS server and the search engine 46 associated with the HCS processes the search against the content catalogue database 48 and returns the results to the ALUI.

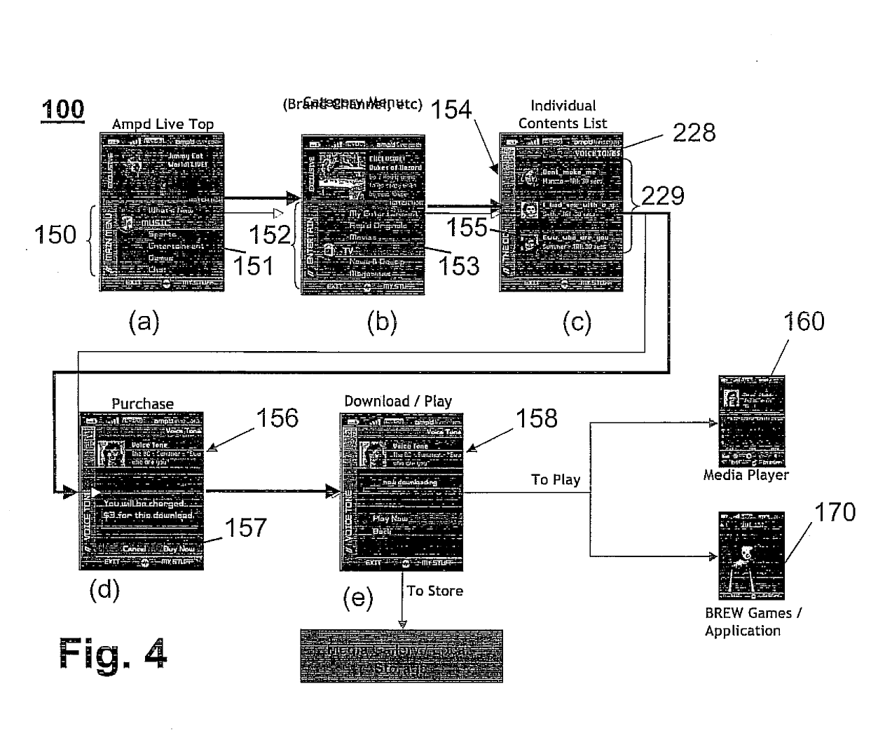

More particularly, with reference now to the handset's user interface 100 shown in FIG. 4, the following is a list of the comprehensive features that are enabled by the ALUI application according to the present invention: a Media Rich UI Presentation with Video Preview functionality; Content Catalogue Browsing functionality; Contents Search, Contents data caching, Content preview, purchase and download (including streaming preview of video/music); launching of external applications for contents preview and play; changing skin themes according to user preferences; the automated downloading of preload contents purchased/selected when a subscriber has registered at the host web site; the automated downloading of contents purchased at the host web site web site; the ability to receive a new contents alert and automatically retrieve new contents catalogue; the ability to optionally store purchased contents to removable media; the ability to support various billing models (unlimited, subscription, etc.); implementation of age verification systems for adult contents (e.g., implementing a Billing Common Gateway Interface (BCGI) Age Verification or like age verification system); interface with HCS server for contents catalogue data, skin data downloading; interface with a Video on Demand (VOD) platform to process VOD requests, content download and billing (e.g., “The Platform” 30c); interface with a “Music On Demand”(MOD) platform to process MOD request, content download and billing (e.g., Ztango^{SM}); interface with the Qualcomm's BREW® ADS/BDS development systems 30 respectively, to process BREW® content download and billing; and interface with a Modtone Server (“Moderati”) 30b to process Ringtone/Realtone/Wallpaper content download and billing.

With respect to the Media Rich User Interface, the ALUI provides mobile contents catalogue browsing and purchasing features accompanied with media rich user interface. For example, the downloadable web pages from the HCS server 45 comprise menu choices enabling one or more of the following features: a content preview/promotional video clip (e.g., 5-10 seconds) with or without audio; a content preview image (e.g., animation, still graphics); text information (contents title, price, description, etc).

FIG. 4 particularly illustrates one exemplary use case/menu transition subscribers will go through to browse, catalogue, purchase, download and play contents. The sequence illustrated is implemented via the handset device's ALUI 100. To play particular contents, the ALUI 100 can launch separate application viewer(s) and players, such as a Media Player 160 and BREW Application 170 (including games). Thus, as shown in the exemplary embodiment of FIG. 4, the ALUI 100 provides a first mobile web page display (a) providing a frame including a menu display 150 providing metadata category selections including: music, sports, entertainment, games, chat, live events, etc. Depending upon the category selected, there may be multiple levels of choices. Thus, for example, a user's selection of the “entertainment” category 151 from the web page menu screen 150 results in the downloading of a second ALUI mobile web page (b) including a second display screen 152 an example embodiment of which is shown in FIG. 4, which provides user selectable options such as television (TV), movies, news and gossip, magazines, and the like. Thus, for example, a user's selection of the “TV” category 153 from the web page menu screen 152 results in the downloading of a third ALUI mobile web page (c) including a third display screen 154 an example embodiment of which is shown in FIG. 4. Particularly, the resulting ALUI screen display 154 presents the individual contents list for the particular TV program selected upon user selection of the “TV” category 153 from the menu screen 152. In the exemplary ALUI screen display presented in the third downloaded mobile web page (c), the user has chosen the TV show “The OC”. As presented via the ALUI screen, the user will be presented with a variety of heterogeneous type of content choices (e.g., video clips, ring tones, voice tones, greetings, screensavers, etc.) corresponding to the selected program. For instance, the user, in the example interface shown, has elected to download voicetones associated with characters of “The OC” television program. Upon the user selection of a desired voice tone content, e.g., voice tone 155, from the ALUI interface screen display 154 provided, there is OTA downloaded a further ALUI mobile web page (d) including an ALUI display screen 156 an example embodiment of which is shown in FIG. 4, which enables purchase of the chosen voice tone content chosen via the mobile web page (c). Then, upon user purchase of the desired voice tone content, there is downloaded OTA a further ALUI mobile web page (e) including an ALUI display screen 158 that enables the user to download the content and additionally play back the content on the relevant device (e.g., media player 160). Otherwise, as shown in FIG. 4, the purchased content will be stored in the device's memory for future playback.

With respect to contents catalogue browsing, the mobile user/subscriber can access and browse the contents catalogue database using the ALUI menu. As mentioned, content metadata and category information is managed and provided in XML format from the HCS (Handset Contents Server). By accessing the HCS server, the device's ALUI obtains the latest content catalogue information. In an exemplary embodiment, each content data has the following content metadata viewable from the mobile device's ALUI: Content Title (e.g., Short form/Full); Content Description (e.g., Short/Full); Content Type (e.g., BREW Application, Video Clip, etc.); Content File Size; Content Provider; Content Price (e.g., MSRP); Content Billing Model (e.g., Unlimited Use, Subscription, etc.); and, Additional Information, such as Play length (e.g., video/music), for example.

To facilitate the browsing and downloading experience, the contents data is organized in various categories to provide intuitive and easy access to target contents subscribers are looking for. Each category can have more than one sub-category, possibly in multiple depth layers. The same content may be available in multiple categories.

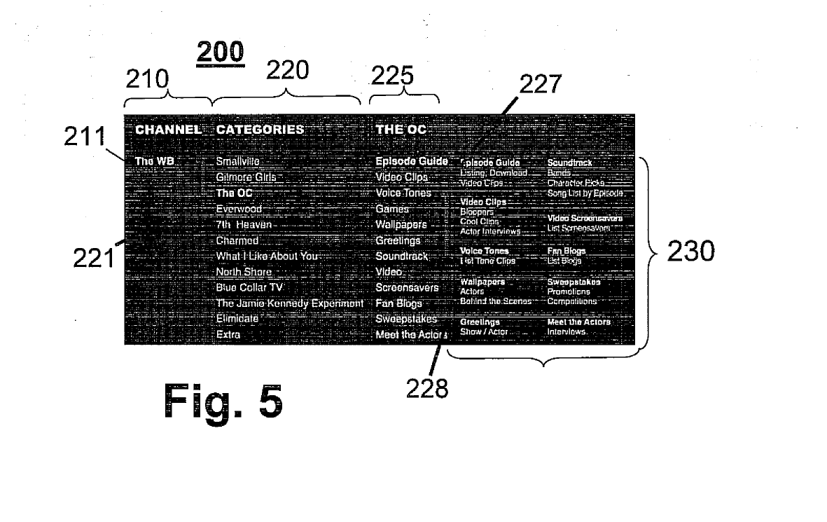

FIG. 5 depicts an example contents catalogue 200 illustrating a contents categorization scheme generated by the CMS that is theme based, e.g., a “Brand Channel” category. This content category schema performed by the CMS exemplifies the bundling approach that enables users, via the device's ALUI, to access all types of downloadable content via a single storefront. Thus, for example, the content categorization schema is a result of aggregating the content into a specific page providing content association, i.e., organizes content according to a hierarchy. For the theme-based “Brand Channel” category, the content is organized to include a first level of TV channels 210, e.g., Warner Bros (WS) channel 211. Content categories 220, e.g., television programs that are associated with that channel are stored in relation. One example of such as a program is “The OC” 221. Upon selection of the particular category 220, in this example, a broadcast program on a channel, all sub-category types 225 of downloadable content associated with the selected category is provided for user selection. As shown in the example relational content storage scheme shown FIG. 5, the sub-category types 225 of downloadable content associated with the selected category “The OC” includes video clips, voice tones, games, wallpaper, greetings, video, screensavers, fan blogs, greetings, soundtrack, sweepstakes, ‘meet the actors’, etc. Thus, user selection of a sub-category 225 will provide the user with all of the corresponding downloadable contents 230 associated with that sub-category including, for example, video clips, voice tones 228, wallpaper, greetings, blogs, etc. Thus, for example, returning to FIG. 4, via the handset's ALUI 100, a user who has navigated through the main menu screen 150 (mobile web page (a)) to select the Entertainment menu choice 151 and then the “TV” sub-menu selection 153 (mobile web page (b)) will be able to navigate to and select the “The OC” program and drill down another level to select the voice tones option 228 (via mobile web page (c)) which presents for display a list of all the voice tones 229 for that program as shown in FIG. 4. From there, as depicted in FIG. 4, a user will be authorized and enabled to purchase and download the selected voice tone. It is understood that, in general, after a user/subscriber selects particular content, the ALUI shows details of the contents including title, description, price, and the estimated OTA time. Upon selection of a “BUY Now” button, such as the button 157 depicted in the exemplary downloaded mobile web page screen display 156 of FIG. 4, there is initiated the downloading of the contents from designated contents distribution servers/networks. The ALUI functionality will enable access to the designated contents distribution server/network over OTA and download selected content to the handset. After selected content is successfully downloaded to the handset, the ALUI transmits a “Complete” acknowledgement message to HCS so that HCS can properly send the billing event to the billing system (BCGI) 52 such as shown in FIG. 2. interfacing with the HCS device 45.

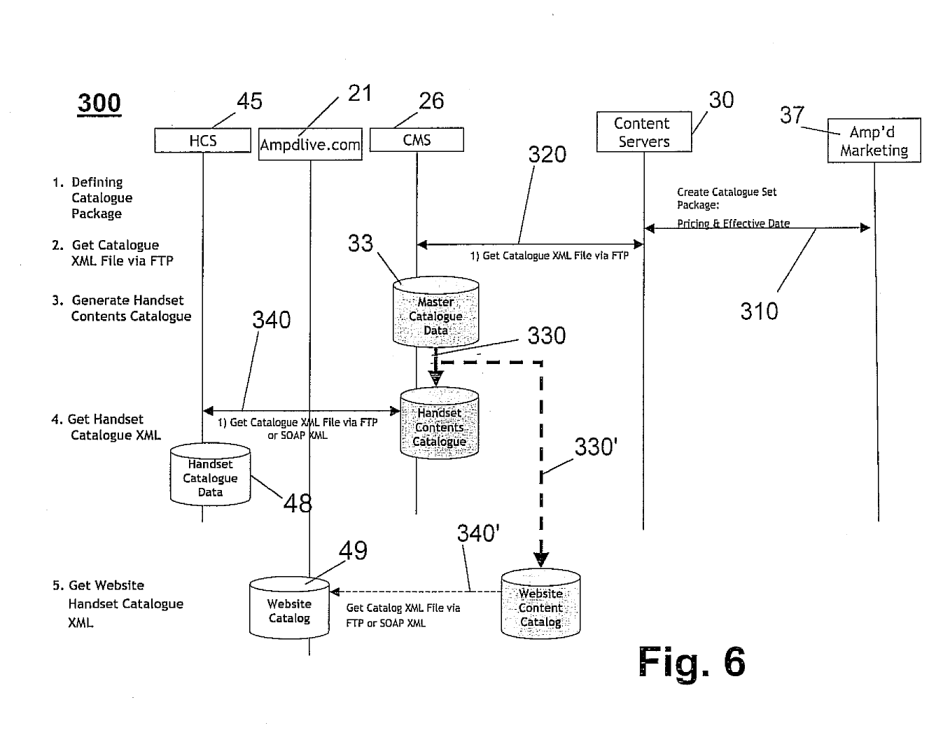

FIG. 6 is a sequence diagram depicting the content bundling process 300 for a mobile device handset back-end infrastructure according to the invention. In the process 300, there is depicted the first step 310 of creating a Set Package Catalogue File whereby a content provider generates and imports the new contents to a marketing and review team where, for example, pricing and effective date information may be determined. Further at step 310, an XML based Package catalogue file is generated and ready for pickup. Then, at step 320, the XML based package catalogue file is downloaded to the CMS server 26 via a File Transfer Protocol (FTP) such as by use of a web services standard such as the Simple Object Access Protocol (XML/SOAP). In one exemplary embodiment, the downloading of XML based package catalogue files occur on a scheduled basis. Once the Set Package Catalogue XML Files arc downloaded to the CMS 26, all MOD catalogue data are merged with other contents catalogue data (Music, Ring, BREW, etc) into Master Catalogue Database 33. Then, at step 330, there is depicted the step of generating a Handset Contents Catalogue whereby the CMS generates Handset specific catalogue data and places it in XML format. This Handset Contents Catalogue XML file includes all catalogue data of all (heterogeneous) contents types including MOD, Video, Ring tones, BREW apps, etc. Finally, at step 340, there is depicted a step of adding the new Handset Catalogue XML files for the mobile handset to the HCS's Handset Catalog database 48. In one embodiment, the HCS 45 periodically downloads the latest Handset Contents Catalogue XML file from the CMS 26 via XML/SOAP or FTP.

Similarly, referring further to FIG. 6, there is depicted an additional feature that enables the same content (XML) presented to the mobile handsets to be presented at the host service provider's website 21 (FIGS. 1, 2). Basically, as shown at step 330′, besides generating the Handset Contents Catalogue, whereby the CMS generates Handset specific catalogue data and places it in XML format, there is additionally generated web-site specific catalogue data placed in XML format for storage at a Website Contents Catalogue XML file including all catalogue data of all (heterogeneous) contents types including MOD, Video, ring tones, BREW apps, etc. that are downloadable to the mobile handset device. Thus, at step 340, FIG. 6, there is depicted a step of enabling a Website Catalogue database 49 to periodically download the latest Website Contents Catalogue XML file from the CMS Website Content Catalog via XML/SOAP or FTP.

The following depicts an exemplary XML data file excerpt 400 representing content that has been ingested in the CMS server and sent to the HCS server from the CMS whose contents will be displayed at the mobile user's handset. The HCS 45 is responsible for updating its live contents catalogue database 48 periodically making the contents from the received XML data files available for the Handset ALUI.

```
- <CatalogData>
    <Vendor Id=“MD” />
  - <ContentCatalog>
      - <Content Id=“MD0113881” Isrc=“”>
          <AcknowledgementURL />
          <LicenseHeaderURL />
          <IconId />
        - <BrandChannelPageId>
            - <![CDATA[ D ]]>
          </BrandChannelPageId>
        - <Title>
          - <![CDATA[ Still Fly ]]>
          </Title>
          <DataType Value=“ringtone” Type=“2” />
          <AccountType>0</AccounType>
        - <Artist>
            - <![CDATA[ Big Tymers ]]>
          </Artist>
          <LongDescription />
          <ShortDescription />
        - <PhoneDescription>
            - <![CDATA[ Still Fly ]]>
          </PhoneDescription>
          <ThumbnailURL />
        - <CategoryList>
              <Category Id=“1353” Name=“Cash Money” />
              <Category Id=“1092” Name=“Hip Hop and Rap” />
              <Category Id=“1056” Name=“Big Tymers” />
              <Category Id=“21” Name=“Hip Hop and Rap” />
          </CategoryList>
        - <Album>
              <AlbumName />
              <AlbumUPC />
              <AlbumArtURL />
          </Album>
        - <Provider>
            - <![CDATA[ Moderati Inc. ]]>
          </Provider>
          <Copyright />
          <Pnotice />
          <Cnotice />
        - <ContentList Currency=“1” DeviceId=“5077” Size=“150”>
          - <ReleaseId Id=“2093013881” Download=“1” Price=“1.99” Duration=“24.00”
                MimeType=“audio/mp3” Drm=“0”>
                - <![CDATA[ http://ampd.modtones.com/ampd-
                  xml/service?act=cnt&tid=13881&hid=209 ]]>
                </ReleaseId>
        </ContentList>
      - <ContentList Currency=“1” DeviceId=“8072” Size=“150”>
          - <ReleaseId Id=“1683013881” Download=“1” Price=“1.99” Duration=“24.00”
              MimeType=“audio/aac” Drm=“0”>
              - <![CDATA[ http://ampd.modtones.com/ampd-
                xml/service?act=cnt&tid=13881&hid=168 ]]>
            </ReleaseId>
        </ContentList>
      - <PreviewList>
          - <Preview Id=“13881” Type=“swf” DeviceId=“0” MimeType=“swf”>
                - <![CDATA[ http://stream.modtones.com/swf/13881.swf ]]>
            </Preview>
        </PreviewList>
        <Rank>0</Rank>
        <Rating>0</Rating>
      - <Dates>
            <EffectiveDate />
            <ExpirationDate />
            <RemovalDate />
        </Dates>
        <Feature />
        <Length />
        <Status Id=“” Description=“” />
        <Subscription>0</Subscription>
        <Live>1</Live>
    </Content>
  </ContentCatalog>
  <DeletedContentIds />
  <DeletedReleaseIds />
</CatalogData>
```

For illustrative purposes, exemplary portions of XML schema (DTD) including element restrictions appurtenant to the foregoing exemplary XML data file that is downloaded to the CMS may include the following:

```
<!ELEMENT CatalogData ( Vendor, ContentCatalog?,
DeletedContentIds?,DeletedReleaseIds? ) >
<!ELEMENT CategoryList ( Category+ ) >
    .....
<!ELEMENT ContentCatalog ( BaseURLs, Content* ) >
    .....
<!ELEMENT Content ( Title, DataType, AccountType, IconId?, Artist?,
LongDescription?, ShortDescription?,
PhoneDescription?, ThumbnailURL?, CategoryList, Album?, Provider?,
Copyright?, PNotice?, CNotice?,
ContentList+, PreviewList*, Rank?, Rating, Dates?, Feature?, Length?,
Status? ) >
where
<!ELEMENT ContentList ( ReleaseId+ ) >
and
<!ATTLIST BaseURL Name ( Content | Thumbnail | Preview |
AlbumArt | Acknowledgement | ContentHeader |
LicenseHeader ) #REQUIRED >
```

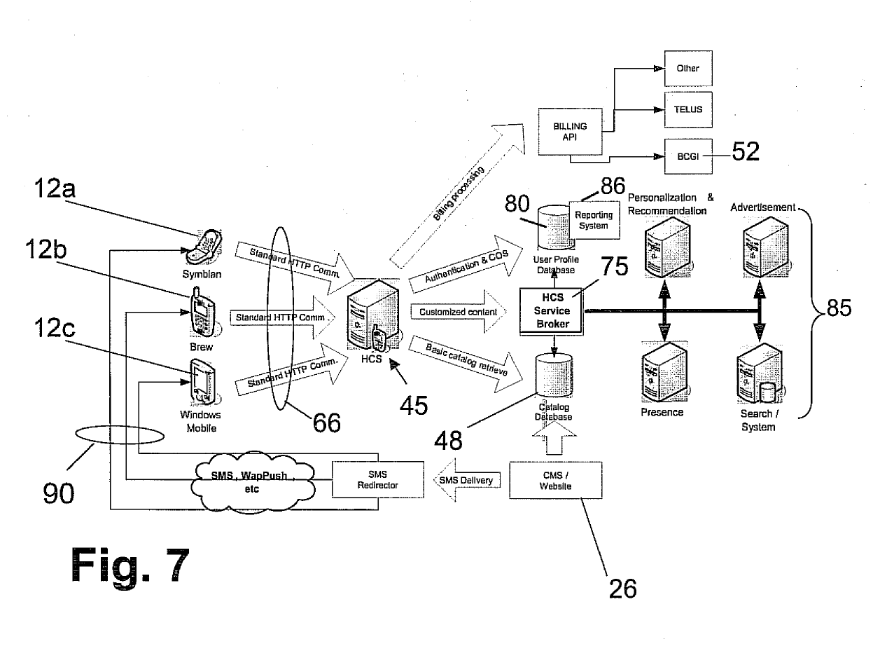

In a variation of, or addition to, the back-end embodiment depicted in FIGS. 1 and 2, the HCS sub-system may comprise an additional HCS service broker functionality that facilitates integration with external systems. More specifically as shown in FIG. 7, a service broker entity, comprising a server device 75: 1) performs integration with all external systems; 2) responds to an HCS request to gather data for user class of service integrating with external systems; and 3) provides a single point of integration between the carrier systems and external systems resulting in a more simple architecture. More particularly, the HCS 45 may respond to standard HTTP communications from one or more handset devices 12a, 12b, 12c regardless of the operating system platform of the device. In the embodiment depicted in FIG. 7, the HCS performs basic static catalog retrieval functions from the catalogue database 48 providing the content information. Additionally, the HCS 45 may respond to standard HTTP communications from a handset device to perform a customized content retrieval via the service broker 75 that dynamically provides content, based on user information from one or more sever devices 85 in networked communication with the service broker 75 that provides new enhancements for the generated web pages such as personalization, advertisements, etc. For example, dynamic content may be retrieved according to a class of service and authentication status based on user profile information stored in a user profile database 85 and retrieved via a reporting system 86. The user profile information may include usage history information as well that is utilized in the provision of customized content for users. Thus, in the alternate embodiment implementing a service broker 75, such as shown in FIG. 7, in response to a given user request, the HCS 45 is provisioned with a template that may indicate (for example) one or more of the following: a banner ad that is displayed at the top (header) of the mobile web page, some text describing the content, e.g., a music album, a graphic associated with the music album, and recommended/related artists, etc. The HCS 45 hands the task of filling in the template to the service broker server 75 that accesses relevant components such as: the user profile for demographic information, the ad server to retrieve an ad that is suitable to the demographic information, CMS for the catalogue meta data, and a recommendation engine to provide “people who liked this, also enjoyed . . . ”—type information. Additionally, the service broker 75 may factor in the user's location information (assuming the handset is a GPS enabled handset), in determining appropriate ads or other content to display. Once the personalized content is retrieved from the various sources, the HCS 45 will construct a web page dynamically to present the new page to the end user.

As mentioned herein, as described with respect to FIGS. 1, 2 and 7, a mobile phone subscriber can browse and purchase mobile contents from the service provider web-site, e.g., the ampd.com web site, as well as from the ALUI on the handset. When the subscriber completes the purchase of contents from the web site, there are potentially two possible scenarios to deliver the contents to the handset. In a first scenario, depicted in FIGS. 1, 2 and 7, delivery is implemented via wake-up short message service (SMS) messaging. With this scenario, the service provider backend servers send special SMS message 90 called “Wake-up SMS” to subscriber's handset upon completion of purchase of contents at the service provider's web site. The handset's ALUI is designed and built so that it can be waken-up (automatically started) and start downloading, via OTA, the actual purchased contents that have been stored in a queue (not shown) when the handset receives the Wake-up SMS message 90. For the scenario where the content download is initiated via the handset's ALUI, the ALUI application will seek the transaction log of web-purchased contents maintained in the HCS. The ALUI periodically accesses the HCS server and checks if there is any entry for web-purchased contents. When the ALUI finds such entry, it automatically starts downloading the contents. This check-up trigger can be commenced when the ALUI application first boots up, or as the result of pre-configured check-up timer when ALUI is up and running.

The present invention has been described with reference to diagrams of methods, apparatus (systems) and computer program products according to embodiments of the invention. It will be understood that each diagram, can be implemented by computer program instructions. These computer program instructions may be provided to a processor of a general purpose computer, special purpose computer, embedded processor or other programmable data processing apparatus to produce a machine, such that the instructions, which execute via the processor of the computer or other programmable data processing apparatus, create means for implementing the functions specified herein.

These computer program instructions may also be stored in a computer-readable memory that can direct a computer or other programmable data processing apparatus to function in a particular manner, such that the instructions stored in the computer-readable memory produce an article of manufacture including instruction means which implement the functions specified herein.

The computer program instructions may also be loaded onto a computer-readable or other programmable data processing apparatus to cause a series of operational steps to be performed on the computer or other programmable apparatus to produce a computer implemented process such that the instructions which execute on the computer or other programmable apparatus provide steps for implementing the functions specified herein.

While there has been shown and described what is considered to be preferred embodiments of the invention, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the appended claims.

Having thus described our invention, what we claim as new, and desire to secure by Letters Patent is:

1. A system for presenting digital content on a mobile phone, said phone including a user interface adapted for initiating search requests for digital content associated with a searched category and downloading digital content, said system comprising:
a first means (CMS) for receiving metadata content describing digital content available for download to a user's digital phone from one or more content providers, said first means further aggregating metadata content including heterogeneous content types and generating a catalogue representing said aggregated metadata content; and,
a second means (HCS) for accessing said aggregated metadata content catalogue and retrieving catalogued metadata in accordance with a received user request, said second means further generating a single web page including metadata from said aggregated metadata content catalogue that is adapted for receipt by said mobile phone and presentation via said user interface,
wherein said first means for aggregating metadata and said second means for retrieving said aggregated metadata catalogue cooperatively interact to provide a user with integrated access to multiple heterogeneous content types via said single web page.

2. The system according to claim 1, wherein said digital content includes one or more of: music, video, wallpaper, screensavers and ringtones, downloadable via said user interface.

3. The system according to claim 2, wherein said aggregated metadata catalogue comprises a bundling of metadata content associated with said heterogeneous content types.

4. The system according to claim 3, wherein said bundling of metadata content associated with said heterogeneous content types is theme-based, said second means packaging metadata relating to said heterogeneous content types according to a bundle's theme for download to said mobile phone.

5. The system according to claim 4, wherein said theme-based bundling of metadata content for download to said mobile phone enables a user to customize and create a more personalized mobile entertainment experience.

6. The system according to claim 4, wherein a searched category comprises a theme associated with a brand.

7. The system according to claim 4, wherein a searched category comprises a theme associated with an artist, entertainer, a movie title or song title.

8. The system according to claim 4, wherein a searched category comprises a theme associated with a video, television show, or live event.

9. The system according to claim 4, wherein a searched category comprises a theme associated with a game or sports team.

10. The system according to claim 1, wherein said aggregating includes merging catalogue data with other contents catalogue data.

11. The system according to claim 1, wherein said metadata content received from one or more content providers comprises an XML data file, said aggregated metadata content catalogue comprising one or more XML data files adapted for presenting content to a user as a web page via said phone's user interface.

12. The system according to claim 11, wherein, in response to a user search, said aggregated metadata content catalogue is provided to said mobile phone as a web page via transmission over a wireless network, said user interface enabling user selection of content for download via said displayed web page.

13. The system according to claim 12, wherein, in response to user selection of content for download via said displayed web page, said content providers download said selected content via an Over The Air data transmission protocol.

14. The system according to claim 12, wherein said second means includes a first web server device adapted for providing said aggregated metadata content as downloadable mobile web pages for said mobile phone in response to user search requests.

15. The system according to claim 14, wherein said second means includes a second web server device adapted for providing said aggregated metadata content as downloadable web pages to a user's personal computing device via the Internet.

16. The system according to claim 15, wherein said second web server device receives said aggregated metadata catalogue content to enable said user's personal computing device to provide a substantially similar user interface for searching downloadable content as said mobile phone user interface.

17. A method for providing digital content on a mobile phone, said phone including a user interface adapted for initiating search requests for digital content associated with a searched category and downloading digital content, said method comprising:
receiving metadata content describing digital content available for download to a user's digital phone at a first server device (CMS) from one or more content providers;
aggregating, at said first server device, said received metadata content including heterogeneous content types and generating a catalogue representing said aggregated metadata content;
accessing, at a second server device (HCS), said aggregated metadata content catalogue and retrieving catalogued metadata in accordance with a received user request; and,
generating a single web page including metadata from said aggregated metadata content catalogue that is adapted for receipt by said mobile phone and presentation via said user interface, thereby providing a user with integrated access to multiple heterogeneous content types via said single web page.

18. The method according to claim 17, wherein said digital content includes one or more of: music, video, wallpaper, screensavers and ring tones, downloadable via said user interface.

19. The method according to claim 18, wherein said aggregating of said received metadata content includes a bundling of metadata content associated with said heterogeneous content types.

20. The method according to claim 19, wherein said bundling of metadata content associated with said heterogeneous content types is theme-based, said method further comprising:
packaging metadata relating to said heterogeneous content types according to a bundle's theme for download to said mobile phone.

21. The method according to claim 20, wherein said theme-based bundling of metadata content for download to said mobile phone enables a user to customize and create a more personalized mobile entertainment experience.

22. The method according to claim 21, wherein a searched category comprises a theme associated with: a brand, an artist, an entertainer, a movie title, a song title, a television show, a video, a game, a sports team, or a live event.

23. The method according to claim 17, wherein said aggregating includes merging catalogue data with other contents catalogue data.

24. The method according to claim 17, wherein said metadata content received from one or more content providers comprises an XML data file, said aggregated metadata content catalogue comprising one or more XML data files adapted for presenting content to a user as a web page via said phone's user interface.

25. The method according to claim 24, wherein, in response to a user search, said aggregated metadata content catalogue is provided to said mobile phone as a web page via transmission over a wireless network, said user interface enabling user selection of content for download via said displayed web page.

26. The method according to claim 25, wherein, in response to user selection of content for download via said displayed web page, downloading, by said content providers, of said selected content via an Over The Air data transmission protocol.

27. The method according to claim 26, wherein said second device includes a first web server device adapted for providing said aggregated metadata content as downloadable mobile web pages for said mobile phone in response to user search requests.

28. The method according to claim 26, wherein said second device includes a second web server device adapted for providing said aggregated metadata content as downloadable web pages to a user's personal computing device via the Internet.

29. The method according to claim 28, wherein said second web server device receives said aggregated metadata catalogue content to enable said user's personal computing device to provide a substantially similar user interface for searching downloadable content as said mobile phone user interface.

30. A program storage device readable by a machine, tangibly embodying a program of instructions executable by the machine to perform method steps for providing digital content on a mobile phone, said phone including a user interface adapted for initiating search requests for digital content associated with a searched category and downloading digital content, said method steps comprising:
receiving metadata content describing digital content available for download to a user's digital phone at a first server device (CMS) from one or more content providers;
aggregating, at said first server device, said received metadata content including heterogeneous content types and generating a catalogue representing said aggregated metadata content;
accessing, at a second server device, said aggregated metadata content catalogue and retrieving catalogued metadata in accordance with a received said user request; and,
generating a single web page including metadata from said aggregated metadata content catalogue that is adapted for receipt by said mobile phone and presentation via said user interface, thereby providing a user with integrated access to multiple heterogeneous content types via said single web page.
